(19) United States
(12) Patent Application Publication
(10) Pub. No.: US 2022/0251246 A1
(43) Pub. Date: Aug. 11, 2022

(54) CARBOXYTERMINATED DIENE RUBBERS

(71) Applicant: ARLANXEO DEUTSCHLAND GMBH, Dormagen (DE)

(72) Inventor: Norbert STEINHAUSER, Dormagen (DE)

(73) Assignee: ARLANXEO DEUTSCHLAND GMBH, Dormagen (DE)

(21) Appl. No.: 17/628,101

(22) PCT Filed: Jul. 14, 2020
(86) PCT No.: PCT/EP2020/069846

§ 371 Date: Jan. 18, 2022

(30) Foreign Application Priority Data
Jul. 16, 2019 (EP) 19186585.6

(51) Int. Cl. C08C 19/36; C08C 19/22; C08C 19/44; B60C 1/00

(52) U.S. Cl. CPC C08C 19/36; B60C 1/0016; C08C 19/44; C08C 19/22

(57) ABSTRACT

The invention relates to carboxyterminated diene rubbers, their production and use.

The invention pertains to carboxyterminated diene rubbers, their production and use.

Important properties of tire treads are good adhesion to dry and wet surfaces, low rolling resistance and high abrasion resistance. It is very difficult to improve the skid resistance of a tire without simultaneously reducing rolling resistance and abrasion resistance. Low rolling resistance is important for low fuel consumption, and high abrasion resistance is the decisive factor for high mileage.

The wet slip resistance and rolling resistance of a tire tread largely depend on the dynamic mechanical properties of the rubbers used in compound manufacture. Rubbers with high rebound elasticity at higher temperatures (60° C. to 100° C.) are used for the tread to reduce rolling resistance. On the other hand, rubbers with a high damping factor at low temperatures (0 to 23° C.) or low rebound elasticity in the range 0° C. to 23° C. are advantageous for improving wet grip. In order to meet this complex requirement profile, compounds of various rubbers are used in the tread. Usually mixtures of one or more rubbers with a relatively high glass transition temperature, such as styrene-butadiene rubber, and one or more rubbers with a relatively low glass transition temperature, such as polybutadiene with a high 1,4-cis content or a styrene-butadiene rubber with a low styrene and vinyl content or a polybutadiene produced in solution with an average 1,4-cis and low vinyl content are used.

Unsaturated anionically polymerized solution rubbers, such as solution polybutadiene and solution styrene-butadiene rubbers, have advantages over corresponding emulsion rubbers in the production of low rolling resistance tire treads. The advantages include the controllability of the vinyl content and the associated glass transition temperature and molecule branching. In practical application, this results in particular advantages in the relationship between wet slip resistance and rolling resistance of the tire. Significant contributions to energy dissipation and thus to rolling resistance in tire treads result from free polymer chain ends and from the reversible build-up and breakdown of the filler network, which is formed by the filler used in the tire tread compound (mostly silica and/or carbon black).

The introduction of functional groups at the polymer chain ends and/or at the polymer chain beginnings enables a physical or chemical bonding of these polymer chain ends or beginnings to the filler surface. This restricts their mobility and thus reduces energy dissipation under dynamic stress on the tread. At the same time, these functional groups can improve the dispersion of the filler in the tire tread, which can lead to a weakening of the filler network and thus to a further reduction in rolling resistance.

To this end, numerous methods for end-group modification of diene rubbers have been developed. For example, EP 0 180 141 A1 describes the use of 4,4′-bis(dimethyl-amino)-benzophenone or N-methylcaprolactam as functionalization reagents. The use of ethylene oxide and N-vinylpyrrolidone is also known from EP 0 864 606 A1. A number of other possible functionalization reagents are listed in U.S. Pat. No. 4,417,029.

Methods for introducing functional groups at the polymer chain start by means of functional anionic polymerization initiators are described for example in EP 0 513 217 A1 and EP 0 675 140 A1 (initiators with protected hydroxyl group), US 2008/0308204 A1 (initiators containing thioethers) as well as in U.S. Pat. No. 5,792,820, EP 0 590 490 A1 and EP 0 594 107 A1 (alkali amides of secondary amines as polymerization initiators).

In particular, silanes and cyclosiloxanes having in total at least two halogen and/or alkoxy and/or aryloxy substituents on silicon are well suited for the end group functionalization of diene rubbers, since one of the substituents mentioned on the Si atom can be easily replaced by an anionic diene polymer chain end in a rapid substitution reaction and the further substituent or substituents mentioned above on Si is or are available as a functional group which can interact with the filler of the tire tread compound, if appropriate after hydrolysis. Examples of such silanes can be found in U.S. Pat. Nos. 3,244,664, 4,185,042, EP 0 778 311 A1 and US 2005/0203251 A1.

As a rule, these silanes have functional groups which are bonded directly to the Si atom or connected to Si via a spacer and which can interact with the surface of the silica filler in the rubber compound. These functional groups are usually alkoxy groups or halogens directly attached to Si, or tertiary amino substituents attached to Si via a spacer. Disadvantages of these silanes are the possible reaction of several anionic polymer chain ends per silane molecule, elimination of interfering components and coupling under formation of Si—O—Si bonds during processing and storage. The introduction of carboxy groups by means of these silanes is not described.

The carboxy group as a strongly polar, bidentate ligand can interact particularly well with the surface of the silica filler in the rubber mixture. Methods for introducing carboxy groups along the polymer chain of diene rubbers produced in solution are known and described for example in DE 26 531 44 A1, EP 1 000 971 A1, EP 1 050 545 A1, WO 2009/034001 A1. These methods have several disadvantages, for example that long reaction times are required, that only an incomplete conversion of the functionalization reagents takes place and that a change of the polymer chains occurs by side reactions such as branching. In addition, these methods do not enable the particularly effective functionalization of the polymer chain ends.

The introduction of carboxy groups at the chain ends of diene rubbers is also described, for example in U.S. Pat. No. 3,242,129 by reacting the anionic polymer chain ends with CC₂. The disadvantage of this method is that the polymer solution has to be brought into contact with gaseous CC₂, which is difficult due to the high viscosity and the resulting poor mixing. In addition, difficult to control coupling reactions occur due to the reaction of more than one polymer chain end at the carbon atom of CC₂. The reaction of the carbanionic polymer chain ends with cyclic anhydrides is also unsuitable for the introduction of carboxy groups, since here too the coupling reaction predominates due to the reaction of more than one chain end per cyclic anhydride molecule. This coupling can be avoided by sequential reaction of the carbanionic polymer chain ends first with ethylene oxide or propylene oxide and subsequent reaction of the now alkoxide polymer chain ends with a cyclic anhydride (U.S. Pat. No. 4,465,809). Here, too, however, the disadvantage is that gaseous and highly toxic ethylene oxide or propylene oxide must be added to the highly viscous rubber solution. In addition, the reaction of the alkoxide chain ends with the cyclic anhydride forms ester bonds that are susceptible to hydrolysis and can be cleaved during processing and later use.

WO 2014/173706 A1 describes a method for introducing carboxy end groups to diene rubbers by avoiding coupling reactions by using silalactones. Further methods for coupling-free carboxy termination of diene rubbers are not known.

It was an object of the invention to provide carboxyterminated diene rubbers and a method for the production thereof, which do not have the disadvantages of the state of the art and in particular make it possible to use easily accessible raw materials for functionalization.

To solve this problem, end group functionalized diene rubbers are proposed which have a carboxy group at the polymer chain end which is linked to the polymer chain via two amide groups, namely —C(═O)NR₃—R₁—NR₂—C(═O)—R₄—, as shown in formula (I),

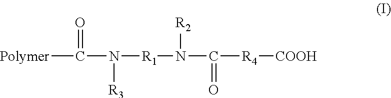

wherein
R₂, R₃ are identical or different and represent saturated or unsaturated organic radicals which may contain one or more heteroatoms, preferably independently of one another selected from O, N, S or Si; and
R₁, R₄ are identical or different and represent saturated or unsaturated divalent organic radicals which, in addition to C and H, may contain one or more heteroatoms, preferably independently of one another selected from O, N, S or Si.

The end group functionalized diene rubbers according to the invention may preferably be present as carboxylates according to formula (II),

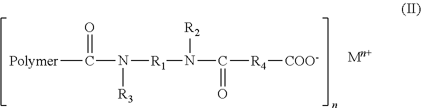

wherein
R₂, R₃ are identical or different and represent saturated or unsaturated organic radicals which may contain one or more heteroatoms, preferably independently of one another selected from O, N, S or Si;
R₁, R₄ are identical or different and represent saturated or unsaturated divalent organic radicals which, in addition to C and H, may contain one or more heteroatoms, preferably independently of one another selected from O, N, S or Si;
n is an integer from 1 to 4; and
M is a metal or semi-metal of valency 1 to 4, preferably Li, Na, K, Mg, Ca, Zn, Fe, Co, Ni, Al, Nd, Ti, Sn, Si, Zr, V, Mo or W.

In preferred embodiments,
R₁ and R₄ are, independently from one another, selected from the group consisting of
   (i) —C₁-C₆-alkylene-, saturated or unsaturated, unsubstituted, mono- or polysubstituted;
   (ii) —C₁-C₆-heteroalkylene-, saturated or unsaturated, unsubstituted, mono- or polysubstituted; and
   (iii) 6-14-membered arylene, unsubstituted, mono- or polysubstituted;
      and/or
R₂ and R₃ are, independently from one another, selected from the group consisting of
   (i) —C₁-C₂₄-alkyl, saturated or unsaturated, unsubstituted, mono- or polysubstituted;
   (ii) —C₁-C₂₄-heteroalkyl, saturated or unsaturated, unsubstituted, mono- or polysubstituted;
   (iii) 6-24-membered aryl, unsubstituted, mono- or polysubstituted, wherein said 6-24-membered aryl is optionally connected through —C₁-C₆-alkylene- or —C₁-C₆-heteroalkylene-, in each case saturated or unsaturated, unsubstituted, mono- or polysubstituted;
   (iv) 5-24-membered heteroaryl, unsubstituted, mono- or polysubstituted; wherein said 5-24-membered heteroaryl is optionally connected through —C₁-C₆-alkylene- or —C₁-C₆-heteroalkylene-, in each case saturated or unsaturated, unsubstituted, mono- or polysubstituted;
   (v) 3-24-membered cycloalkyl, saturated or unsaturated, unsubstituted, mono- or polysubstituted; wherein said 3-24-membered cycloalkyl is optionally connected through —C₁-C₆-alkylene- or —C₁-C₆-heteroalkylene-, in each case saturated or unsaturated, unsubstituted, mono- or polysubstituted; and
   (vi) 3-24-membered heterocycloalkyl, saturated or unsaturated, unsubstituted, mono- or polysubstituted; wherein said 3-24-membered heterocycloalkyl is optionally connected through —C₁-C₆-alkylene- or —C₁-C₆-heteroalkylene-, in each case saturated or unsaturated, unsubstituted, mono- or polysubstituted;
      wherein “mono- or polysubstituted” in each case independently means substituted with one or more substituents independently of one another selected from —F, —Cl, —Br, —I, —CN, ═O, —CF₃, —CF₂H, —CFH₂, —CF₂Cl, —CFCl₂, —C₁-C₁₈-alkyl, saturated or unsaturated, unsubstituted and —C₁-C₁₈-heteroalkyl, saturated or unsaturated, unsubstituted.

In other preferred embodiments,
R₁ is (i) —C₁-C₆-alkylene-, saturated or unsaturated, unsubstituted; preferably (ii) —C₁-C₂-alkylene-, saturated or unsaturated, unsubstituted; and/or
R₂ and R₃ are, independently from one another, (i) —C₁-C₆-alkyl, saturated or unsaturated, unsubstituted; preferably (ii) —C₁-C₂-alkyl, saturated or unsaturated, unsubstituted; and/or
R₄ is (i) —C₁-C₆-alkylene-, saturated or unsaturated, unsubstituted, mono- or polysubstituted; preferably (ii) —C₁-C₃-alkylene-, saturated or unsaturated, unsubstituted, mono- or polysubstituted;
   wherein in each case “mono- or polysubstituted” means substituted with one or more substituents independently of one another selected from
—F, —Cl, —Br, —I, —CN, —CF₃, —CF₂H, —CFH₂, —CF₂Cl, —CFCl₂,
—C₁-C₁₈-alkyl, saturated or unsaturated, unsubstituted, and
—C₁-C₁₈-heteroalkyl, saturated or unsaturated, unsubstituted.

Preferably, “mono- or polysubstituted” in the context of the above preferred embodiments means substituted with one or more substituents independently of one another selected from
—C₁-C₁₈-alkyl, saturated, unsubstituted, and
—C₁-C₆-alkyl-Si(O—C₁-C₆-alkyl)₃, wherein in each case —C₁-C₆-alkyl is saturated, unsubstituted.

In a particularly preferred embodiment of the carboxyterminated polymer according to the invention,
R₁ is —C₁-C₂-alkylene-, saturated or unsaturated, unsubstituted; and/or
R₂ is —C₁-C₂-alkyl, saturated or unsaturated, unsubstituted; and/or
R₃ is —C₁-C₂-alkyl, saturated or unsaturated, unsubstituted; and/or
R₄ is —C₁-C₃-alkylene-, saturated or unsaturated, unsubstituted, mono- or polysubstituted;
   wherein in each case “mono- or polysubstituted” means substituted with one or more substituents independently of one another selected from C₁-C₁₈-alkyl, saturated or unsaturated, unsubstituted, and C₁-C₁₈-heteroalkyl, saturated or unsaturated, unsubstituted.

The following definitions apply:

The term “polymer” as used herein corresponds to the same-named residue contained in the compounds according to formulae (I) and (II).

The term “alkyl, saturated or unsaturated” as used herein encompasses saturated alkyl as well as unsaturated alkyl such as alkenyl, alkynyl, and the like. The term “alkyl” as used herein means normal, secondary, or tertiary, linear or branched hydrocarbon with no site of unsaturation. Examples are methyl, ethyl, 1-propyl (n-propyl), 2-propyl (iPr), 1-butyl, 2-methyl-1-propyl(i-Bu), 2-butyl (s-Bu), 2-dimethyl-2-propyl (t-Bu), 1-pentyl (n-pentyl), 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, and 3,3-dimethyl-2-butyl. The term “alkenyl” as used herein means normal, secondary or tertiary, linear or branched hydrocarbon with at least one site (usually 1 to 3, preferably 1) of unsaturation, namely a carbon-carbon, sp2 double bond. Examples include, but are not limited to: ethylene or vinyl (—CH═CH₂), allyl (—CH₂CH═CH₂), and 5-hexenyl (—CH₂CH₂CH₂CH₂CH═CH₂). The double bond may be in the cis or trans configuration. The term “alkynyl” as used herein means normal, secondary, tertiary, linear or branched hydrocarbon with at least one site (usually 1 to 3, preferably 1) of unsaturation, namely a carbon-carbon, sp triple bond. Examples include, but are not limited to: ethynyl (—C═CH), and 1-propynyl (propargyl, —CH₂C═CH).

The term “alkylene, saturated or unsaturated” as used herein encompasses saturated alkylene as well as unsaturated alkylene such as alkenylene, alkynylene, alkenynylene and the like. The term “alkylene” as used herein means saturated, linear or branched chain hydrocarbon radical having two monovalent radical centers derived by the removal of two hydrogen atoms from the same or two different carbon atoms of a parent alkane. Typical alkylene radicals include, but are not limited to: methylene (—CH₂—), 1,2-ethyl (—CH₂CH₂—), 1,3-propyl (—CH₂CH₂CH₂—), 1,4-butyl (—CH₂CH₂CH₂CH₂—), and the like. The term “alkenylene” as used herein means linear or branched chain hydrocarbon radical with at least one site (usually 1 to 3, preferably 1) of unsaturation, namely a carbon-carbon, sp2 double bond, and having two monovalent radical centers derived by the removal of two hydrogen atoms from the same or two different carbon atoms of a parent alkene. The term “alkynylene” as used herein means linear or branched chain hydrocarbon radical with at least one site (usually 1 to 3, preferably 1) of unsaturation, namely a carbon-carbon, sp triple bond, and having two monovalent radical centers derived by the removal of two hydrogen atoms from the same or two different carbon atoms of a parent alkyne.

The term “heteroalkyl, saturated or unsaturated” as used herein encompasses saturated heteroalkyl as well as unsaturated heteroalkyl such as heteroalkenyl, heteroalkynyl, heteroalkenynyl and the like. The term “heteroalkyl” as used herein means linear or branched chain alkyl wherein one or more carbon atoms (usually 1, 2 or 3) are replaced by a heteroatom, i.e. an oxygen, nitrogen, sulfur or silicon atom, with the proviso that said chain may not contain two adjacent O atoms or two adjacent S atoms. This means that one or more —CH₃ of said alkyl can be replaced by —NH₂ and/or that one or more —CH₂— of said alkyl can be replaced by —NH—, —O—, —S— or —Si—. The S atoms in said chains may be optionally oxidized with one or two oxygen atoms, to afford sulfoxides and sulfones, respectively. Furthermore, the heteroalkyl groups in the benzofurane derivatives of the invention can contain an oxo or thio group at any carbon or heteroatom that will result in a stable compound. Exemplary heteroalkyl groups include, but are not limited to, alcohols, alkyl ethers (such as for example -methoxy, -ethoxy, -butoxy, . . . ), primary, secondary, and tertiary alkyl amines, amides, ketones, esters, alkyl sulfides, and alkyl sulfones. The term “heteroalkenyl” means linear or branched chain alkenyl wherein one or more carbon atoms (usually 1, 2 or 3) are replaced by an oxygen, nitrogen or sulfur atom, with the proviso that said chain may not contain two adjacent O atoms or two adjacent S atoms. The term heteroalkenyl thus comprises imines, —O-alkenyl, —NH-alkenyl, —N(alkenyl)₂, —N(alkyl)(alkenyl), and —S-alkenyl. The term “heteroalkynyl” as used herein means linear or branched chain alkynyl wherein one or more carbon atoms (usually 1, 2 or 3) are replaced by an oxygen, nitrogen or sulfur atom, with the proviso that said chain may not contain two adjacent O atoms or two adjacent S atoms. The term heteroalkynyl thus comprises -cyano, —O-alkynyl, —NH-alkynyl, —N(alkynyl)₂, —N(alkyl)(alkynyl), —N(alkenyl)(alkynyl), and —S-alkynyl.

The term “heteroalkylene, saturated or unsaturated” as used herein encompasses saturated heteroalkylene as well as unsaturated heteroalkylene such as heteroalkenylene, heteroalkynylene, heteroalkenynylene and the like. The term “heteroalkylene” as used herein means linear or branched chain alkylene wherein one or more carbon atoms (usually 1, 2 or 3) are replaced by a heteroatom, i.e. an oxygen, nitrogen or sulfur atom, with the proviso that said chain may not contain two adjacent O atoms or two adjacent S atoms. The term “heteroalkenylene” as used herein means linear or branched chain alkenylene wherein one or more carbon atoms (usually 1, 2 or 3) are replaced by an oxygen, nitrogen or sulfur atom, with the proviso that said chain may not contain two adjacent O atoms or two adjacent S atoms. The term “heteroalkynylene” as used herein means linear or branched chain alkynylene wherein one or more carbon atoms (usually 1, 2 or 3) are replaced by an oxygen, nitrogen or sulfur atom, with the proviso that said chain may not contain two adjacent O atoms or two adjacent S atoms.

The term “cycloalkyl, saturated or unsaturated” as used herein encompasses saturated cycloalkyl as well as unsaturated cycloalkyl such as cycloalkenyl, cycloalkynyl and the like. The term “cycloalkyl” as used herein and unless otherwise stated means a saturated cyclic hydrocarbon radical, such as for instance cyclopropyl, cyclobutyl, cyclopentyl, cyclohexyl, cycloheptyl, cyclooctyl, norbornyl, fenchyl, decalinyl, adamantyl and the like. The term “cycloalkenyl” as used herein means a non-aromatic cyclic hydrocarbon radical with at least one site (usually 1 to 3, preferably 1) of unsaturation, namely a carbon-carbon, sp2 double bond. Examples include, but are not limited to cyclopentenyl and cyclohexenyl. The double bond may be in the cis or trans configuration. The term “cycloalkynyl” as used herein means a non-aromatic cyclic hydrocarbon radical with at least one site (usually 1 to 3, preferably 1) of unsaturation, namely a carbon-carbon, sp triple. An example is cyclohept-1-yne. Fused systems of a cycloalkyl ring with a heterocycloalkyl ring are considered as heterocycloalkyl irrespective of the ring that is bound to the core structure. Fused systems of a cycloalkyl ring with an aryl ring are considered as aryl irrespective of the ring that is bound to the core structure. Fused systems of a cycloalkyl ring with a heteroaryl ring are considered as heteroaryl irrespective of the ring that is bound to the core structure.

The term “heterocycloalkyl, saturated or unsaturated” as used herein encompasses saturated heterocycloalkyl as well as unsaturated non-aromatic heterocycloalkyl including at least one heteroatom, i.e. an N, O, or S as ring member. The term “heterocycloalkyl” as used herein and unless otherwise stated means “cycloalkyl” wherein one or more carbon atoms (usually 1, 2 or 3) are replaced by an oxygen, nitrogen or sulfur atom, with the proviso that said chain may not contain two adjacent O atoms or two adjacent S atoms. The term “heterocycloalkenyl” as used herein and unless otherwise stated means “cycloalkenyl” wherein one or more carbon atoms (usually 1, 2 or 3) are replaced by an oxygen, nitrogen or sulfur atom, with the proviso that said chain may not contain two adjacent O atoms or two adjacent S atoms. The term “heterocycloalkynyl” as used herein and unless otherwise stated means “cycloalkynyl” wherein one or more carbon atoms (usually 1, 2 or 3) are replaced by an oxygen, nitrogen or sulfur atom, with the proviso that said chain may not contain two adjacent O atoms or two adjacent S atoms. Examples of saturated and unsaturated heterocycloalkyl include but are not limited to azepane, 1,4-oxazepane, azetane, azetidine, aziridine, azocane, diazepane, dioxane, dioxolane, dithiane, dithiolane, imidazolidine, isothiazolidine, isoxalidine, morpholine, oxazolidine, oxepane, oxetane, oxirane, piperazine, piperidine, pyrazolidine, pyrrolidine, quinuclidine, tetrahydrofurane, tetrahydropyrane, tetrahydrothiopyrane, thiazolidine, thietane, thiirane, thiolane, thiomorpholine, indoline, dihydrobenzofurane, dihydrobenzothiophene, 1,1-dioxothiacyclohexane, 2-azaspiro[3.3]heptane, 2-oxaspiro[3.3]heptane, 7-azaspiro[3.5]nonane, 8-azabicyclo-[3.2.1]octane, 9-azabicyclo[3.3.1]nonane, hexahydro-1H-pyrrolizine, hexahydrocyclopenta[c]pyrrole, octahydrocyclopenta[c]pyrrole, and octahydropyrrolo[1,2-a]pyrazin. Further heterocycloalkyls in the meaning of the invention are described in Paquette, Leo A. “Principles of Modern Heterocyclic Chemistry” (W. A. Benjamin, New York, 1968), particularly Chapters 1, 3, 4, 6, 7, and 9; “The Chemistry of Heterocyclic Compounds, A series of Monographs” (John Wiley & Sons, New York, 1950 to present), in particular Volumes 13, 14, 16, 19, and 28; Katritzky, Alan R., Rees, C. W. and Scriven, E. “Comprehensive Heterocyclic Chemistry” (Pergamon Press, 1996); and J. Am. Chem. Soc. (1960) 82:5566. When the heterocycloalkyl contains no nitrogen as ring member, it is typically bonded through carbon. When the heterocycloalkyl contains nitrogen as ring member, it may be bonded through nitrogen or carbon. Fused systems of heterocycloalkyl ring with a cycloalkyl ring are considered as heterocycloalkyl irrespective of the ring that is bound to the core structure. Fused systems of a heterocycloalkyl ring with an aryl ring are considered as heterocycloalkyl irrespective of the ring that is bound to the core structure. Fused systems of a heterocycloalkyl ring with a heteroaryl ring are considered as heteroaryl irrespective of the ring that is bound to the core structure.

The term “aryl” as used herein means an aromatic hydrocarbon. Typical aryl groups include, but are not limited to 1 ring, or 2 or 3 rings fused together, radicals derived from benzene, naphthalene, anthracene, biphenyl, and the like. Fused systems of an aryl ring with a cycloalkyl ring are considered as aryl irrespective of the ring that is bound to the core structure. Fused systems of an aryl ring with a heterocycloalkyl ring are considered as heterocycloalkyl irrespective of the ring that is bound to the core structure. Thus, indoline, dihydrobenzofurane, dihydrobenzothiophene and the like are considered as heterocycloalkyl according to the invention. Fused systems of an aryl ring with a heteroaryl ring are considered as heteroaryl irrespective of the ring that is bound to the core structure.

The term “arylene” as used herein means bivalent groups derived from arenes by removal of a hydrogen atom from two ring carbon atoms. A synonym is arenediyl groups. Examples of arylene include but are not limited to phenylene and benzene-1,2-diyl.

The term “heteroaryl” as used herein means an aromatic ring system including at least one heteroatom, i.e. N, O, or S as ring member of the aromatic ring system. Examples of heteroaryl include but are not limited to benzimidazole, benzisoxazole, benzoazole, benzodioxole, benzofurane, benzothiadiazole, benzothiazole, benzothiophene, carbazole, cinnoline, dibenzofurane, furane, furazane, imidazole, imidazopyridine, indazole, indole, indolizine, isobenzofurane, isoindole, isoquinoline, isothiazole, isoxazole, naphthyridine, oxadiazole, oxazole, oxindole, phthalazine, purine, pyrazine, pyrazole, pyridazine, pyridine, pyrimidine, pyrrole, quinazoline, quinoline, quinoxaline, tetrazole, thiadiazole, thiazole, thiophene, triazine, triazole, and [1,2,4]triazolo[4,3-a]pyrimidine.

The term “heteroarylene” as used herein means bivalent groups derived from heteroarenes by removal of a hydrogen atom from two ring carbon atoms.

The end group functionalized diene rubbers according to the invention are prepared or obtainable by homo- and copolymerization of conjugated dienes and by copolymerization of conjugated dienes with vinylaromatic monomers and subsequent reaction with suitable functionalization reagents.

The preferred conjugated dienes are 1,3-butadiene, isoprene, 1,3-pentadiene, 2,3-dimethylbutadiene, 1-phenyl-1,3-butadiene, 1,3-hexadiene, myrcene, ocimenes and/or farnesenes. 1,3-Butadiene and/or isoprene are particularly preferred.

For example, styrene, o-, m- and/or p-methylstyrene, p-tert-butylstyrene, -methylstyrene, vinylnaphthalene, divinylbenzene, trivinylbenzene and/or divinylnaphthalene can be used as vinylaromatic comonomers. Styrene is particularly preferred.

In a particularly preferred embodiment, the carboxyterminated polymer according to the invention comprises a “polymer” that is obtainable by copolymerization of 1,3-butadiene with styrene.

These polymers are preferably prepared or obtainable by anionic solution polymerization or by polymerization using coordination catalysts. Coordination catalysts in this context are

Ziegler-Natta catalysts or monometallic catalyst systems. Preferred coordination catalysts are those based on Ni, Co, Ti, Zr, Nd, V, Cr, Mo, W or Fe.

Initiators for anionic solution polymerization are those based on alkali or alkaline earth metals, e.g. methyl lithium, ethyl lithium, isopropyllithium, n-butyllithium, sec-butyllithium, pentyllithium, n-hexyllithium, cyclohexyllithium, octyllithium, decyl-lithium, 2-(6-lithio-n-hexoxy)tetrahydropyran, 3-(tert-butyldimethylsiloxy)-1-propyllithium, phenyllithium, 4-butyl-phenyllithium, 1-naphthyllithium, p-toluyllithium and allyllithium compounds, derived from tertiary N-allylamines such as [1-(dimethylamino)-2-propenyl]lithium, [1-[bis(phenyl-methyl)amino]-2-propenyl]lithium, [1-(diphenylamino)-2-propenyl]lithium, [1-(1-pyrrolidinyl)-2-propenyl]lithium, Lithium amides of secondary amines such as lithium pyrrolidide, lithium piperidide, lithium hexamethylene imide, lithium 1-methyl imidazolidide, lithium 1-methyl piperazide, lithium morpholide, lithium dicyclohexylamide, lithium dibenzyl amide, lithium diphenyl amide. These allyllithium compounds and these lithium amides can also be prepared in situ by reacting an organolithium compound with the respective tertiary N-allylamines or with the respective secondary amines. Di- and polyfunctional organolithium compounds can also be used, for example 1,4-dilithiobutane, dilithium piperazide. Preferably n-butyllithium and sec-butyllithium are used.

In addition, the well-known randomizers and control agents can be used for the microstructure of the polymer, for example diethyl ether, di-n-propylether, diisopropyl ether, di-n-butylether, ethylene glycol dimethyl ether, Ethylene glycol diethyl ether, ethylene glycol di-n-butyl ether, ethylene glycol di-tert-butyl ether, diethylene glycol dimethyl ether, diethylene glycol diethyl ether, diethylene glycol di-n-butyl ether, diethylene glycol di-tert-butyl ether, 2-(2-ethoxyethoxy)-2-methyl-propane, triethylene glycol dimethyl ether, tetrahydrofuran, ethyltetrahydrofurfuryl ether, hexyltetrahydrofurfuryl ether, 2,2-bis(2-tetrahydrofuryl)propane, dioxane, trimethylamine, triethylamine, N,N,N′,N′-tetramethyl-ethylenediamine, N-methylmorpholine, N-ethylmorpholine, 1,2-dipiperi-dinoethane, 1,2-dipyrrolidinoethane, 1,2-dimorpholinoethane and potassium and sodium salts of alcohols, phenols, carboxylic acids, sulphonic acids.

Such solution polymerizations are well known and described, for example, in I. Franta, Elastomers and Rubber Compounding Materials; Elsevier 1989, pages 113-131, in Houben-Weyl, Methoden der Organischen Chemie, Thieme Verlag, Stuttgart, 1961, volume XIV/1 pages 645 to 673 or in volume E 20 (1987), pages 114 to 134 and pages 134 to 153 as well as in Comprehensive Polymer Science, Vol. 4, Part II (Pergamon Press Ltd., Oxford 1989), pages 53-108.

The production of the preferred diene homo- and diene copolymers preferably takes place in a solvent. The preferred solvents for polymerization are inert aprotic solvents such as aliphatic hydrocarbons such as isomeric butanes, pentanes, hexanes, heptanes, octanes, decanes and cyclopentane, methylcyclopentane, cyclohexane, methylcyclohexane, ethylcyclohexane or 1,4-dimethylcyclohexane or alkenes such as 1-butene or aromatic hydrocarbons such as benzene, toluene, ethylbenzene, xylene, diethylbenzene or propylbenzene. These solvents can be used individually or in combination. Preferred solvents are cyclohexane, methylcyclopentane and n-hexane. Mixing with polar solvents is also possible.

The amount of solvent in the invention process is usually in the range from 100 to 1000 g, preferably in the range from 200 to 700 g, based on 100 g of the total amount of monomer used. However, it is also possible to polymerize the monomers used in the absence of solvents.

Polymerization can be carried out by first introducing the monomers and the solvent and then starting the polymerization by adding the initiator or catalyst. It is also possible to polymerize in a feed process where the polymerization reactor is filled by adding monomers and solvents, the initiator or catalyst being introduced or added with the monomers and solvent. Variations are possible, such as the introduction of the solvent in the reactor, the addition of the initiator or catalyst and then the addition of the monomers. Furthermore, polymerization can be carried out in a continuous mode. Further monomer and solvent addition during or at the end of polymerization is possible in all cases.

The polymerization time can vary from a few minutes to several hours. Polymerization is usually carried out within a period of 10 minutes to 8 hours, preferably 20 minutes to 4 hours. It can be carried out both at normal pressure and at elevated pressure (from 1 to 10 bar).

It was surprisingly found that by successively adding 1) one or more cyclic urea derivatives and 2) one or more cyclic carboxylic acid anhydrides as functionalization reagents, carboxyterminated polymers can be produced which do not have the disadvantages of the state of the art.

The cyclic urea derivatives are compounds of the formula (III)

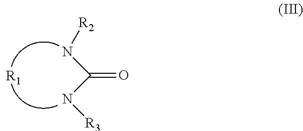

where
R₁ is a saturated or unsaturated divalent organic radical which, in addition to C and H, may contain one or more heteroatoms, preferably independently of one another selected from O, N, S or Si; and
R₂, R₃ are identical or different and represent saturated or unsaturated organic radicals which may contain one or more heteroatoms, preferably independently of one another selected from O, N, S or Si;
   where preferably,
R₁ is a —C₂H₄—, —C₃H₆— or —C₄H₈-alkylene- radical; and
R₂, R₃ are identical or different and are —(C₁-C₂₄)-alkyl, —(C₃-C₂₄)-cycloalkyl, —(C₆-C₂₄)-aryl, —(C₆-C₂₄)-alkaryl or —(C₆-C₂₄)-aralkyl radicals which may contain one or more heteroatoms, preferably independently of one another selected from O, N, S or Si.

Preferably, R₁ is —CH₂—CH₂— and/or R₂ and R₃ are both —CH₃.

Preferred examples of compounds of formula (III) include but are not limited to:

1,3-Dimethyl-2-imidazolidinone (1), 1,3-diethyl-2-imidazolidinone (2), 1-methyl-3-phenyl-2-imidazolidinone (3), 1,3-diphenyl-2-imidazolidinone (4), 1,3-dimethyl-2-imidazolidinone (3), 1,3-dimethyl-2-imidazolidinone (3), 1,3-dimethyl-2-imidazolidinone (3), 1,3-dimethyl-2-imidazolidinone (3), 1,3-dimethyl-2-imidazolidinone (3), 1,3-dimethyl-2-imidazolidinone (4), 1,3-dimethyl-2-imidazolidinone (4), 1,3-dimethyl-2-imidazolidinone (3), 3-diethenyl-2-imidazolidinone (5), 1,3,4-trimethyl-2-imidazolidinone (6), 1,3-bis(trimethylsilyl)-2-imidazolidinone (7), 1,3-dihydro-1,3-dimethyl-2H-imidazol-2-one (8), tetrahydro-1,3-dimethyl-2(1H)-pyrimidinone (9), tetrahydro-1-methyl-3-phenyl-2(1H)-pyrimidinone (10), tetrahydro-1,3,5-trimethyl-2(1H)-pyrimidinone (11), tetrahydro-3,5-dimethyl-4H-1,3,5-oxadiazin-4-one (12), tetrahydro-1,3,5-trimethyl-1,3,5-triazin-2(1H)-one (13), hexahydro-1,3-dimethyl-2H-1,3-diazepin-2-one (14):

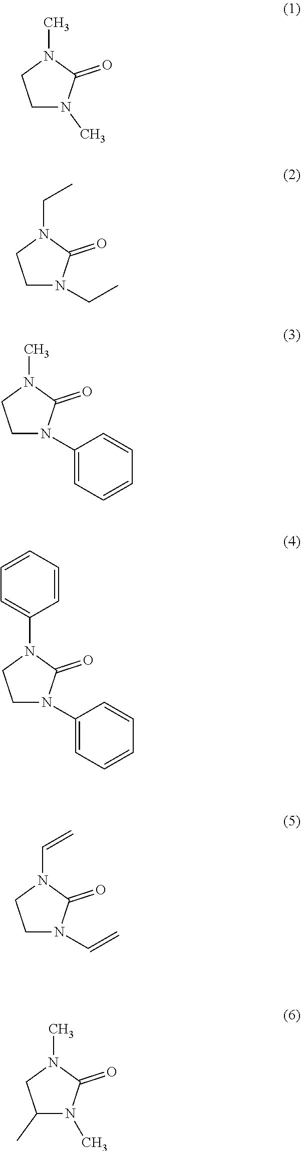

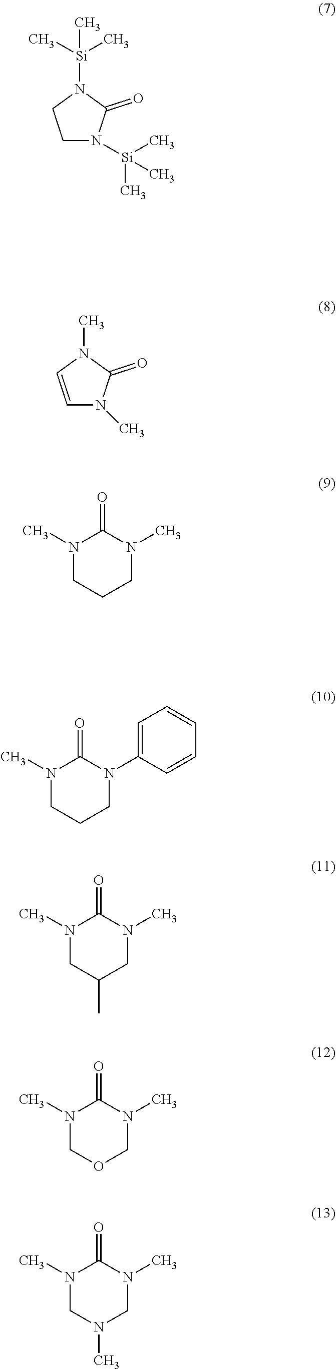

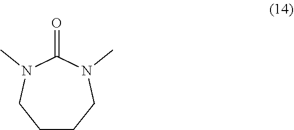

A particularly preferred example of compounds of formula (III) is 1,3-Dimethyl-2-imidazolidinone (1):

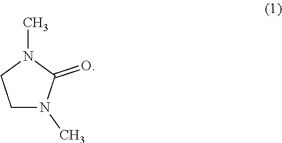

Cyclic carboxylic anhydrides are compounds of formula (IV)

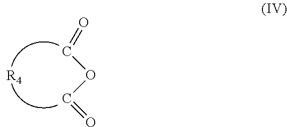

where
R₄ is a saturated or unsaturated divalent organic radical which, in addition to C and H, may contain one or more heteroatoms, preferably independently of one another selected from O, N, S or Si.

Preferably, R₄ is —CH₂—CHCₖH₂ₖ₊₁— wherein k is an integer of from 8 to 16; —CH₂CH((CH₂)₁₋₅Si(OC₁-C₄-alkyl)₃); —CH═CC₁-C₄-alkyl-, or —(CH₂)₂₋₄—.

Preferred examples of compounds of the formula (IV) include but are not limited to:

malonic anhydride (15), 3-methyl-2,4-oxetanedione (16), succinic anhydride (17), methyl succinic anhydride (18), 2,3-dimethyl succinic anhydride (19), tetrapropenyl succinic anhydride (20), isooctadecyl succinic anhydride (21), 3-(trimethoxysilyl)propyl succinic anhydride (22), 3-(triethoxysilyl)propyl succinic anhydride (23), itaconic anhydride (24), maleic anhydride (25), citraconic anhydride (26), dimethyl maleic anhydride (27), phthalic anhydride (28), glutaric anhydride (29), 3-methyl glutaric anhydride (30), 3,3-dimethyl glutaric anhydride (31), 3-tert-butyldimethylsilyl)oxy]glutaric anhydride (32), 3-oxoglutaric anhydride (33), diglycolic anhydride (34), 2,2′-thiodiglycolic anhydride (35), 4-methyl-2,6-morpholine-dione (36), 1H-2-benzopyran-1,3(4H)-dione (37), naphthalic anhydride (38), adipic anhydride (39), pimelic anhydride (40):

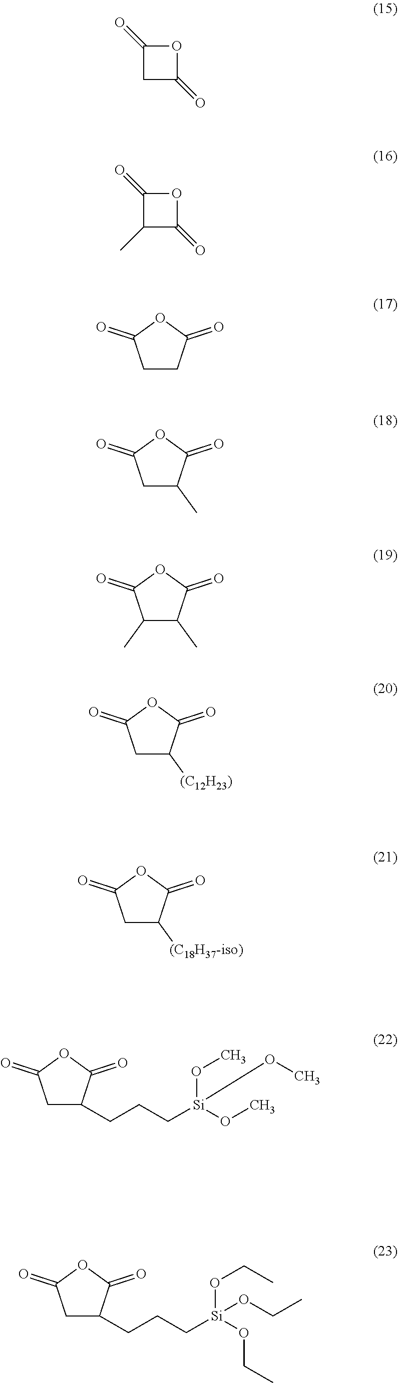

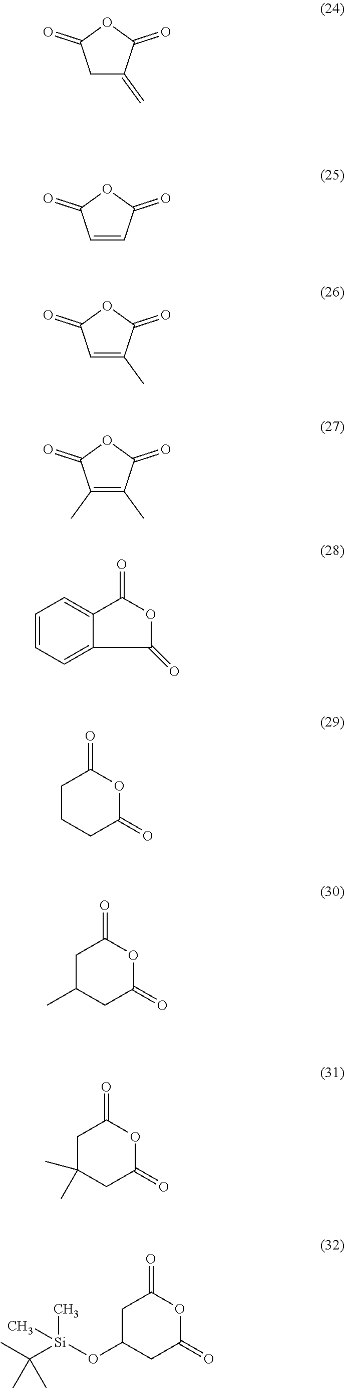

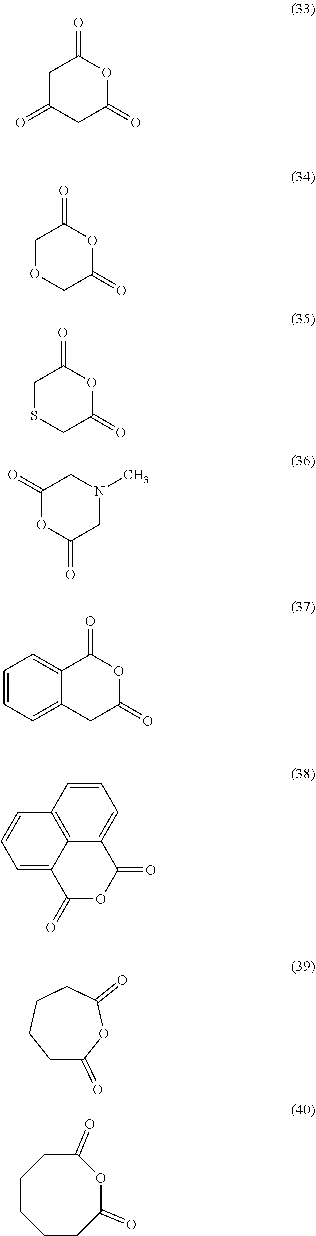

Particularly preferred examples of compounds of the formula (IV) include but are not limited to tetrapropenyl succinic anhydride (20), 3-(trimethoxysilyl)propyl succinic anhydride (22), citraconic anhydride (26), glutaric anhydride (29):

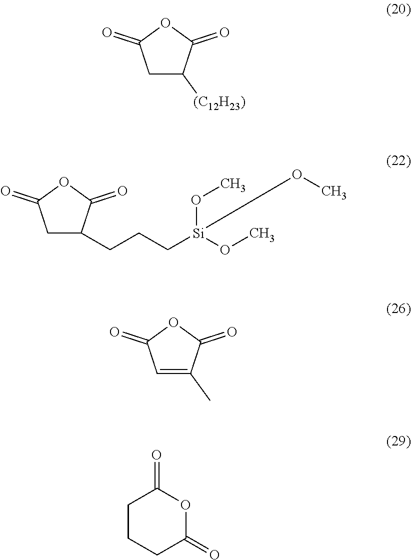

It was found that the end group functionalized diene rubbers according to the invention can be prepared by successive reaction of reactive polymer chain ends from anionic diene polymerization with first a cyclic urea derivative and subsequently with a cyclic carboxylic acid anhydride and optionally, subsequent protonation of the resulting carboxylate end group to the carboxy end group.

In a particularly preferred embodiment of the carboxyterminated polymer according to the invention,
the “polymer” is obtainable by copolymerization of 1,3-butadiene with styrene;
R₁ is —C₁-C₃-alkylene-, saturated or unsaturated, unsubstituted;
R₂ is —C₁-C₂-alkyl, saturated or unsaturated, unsubstituted;
R₃ is —C₁-C₂-alkyl, saturated or unsaturated, unsubstituted; and
R₄ is —C₁-C₃-alkylene-, saturated or unsaturated, unsubstituted, mono- or polysubstituted;
   wherein in each case “mono- or polysubstituted” means substituted with one or more substituents independently of one another selected from —C₁-C₁₈-alkyl, saturated or unsaturated, unsubstituted, and —C₁-C₁₈-heteroalkyl, saturated or unsaturated, unsubstituted; preferably selected from —C₁-C₁₈-alkyl, saturated or unsaturated, unsubstituted or —C₁-C₆-alkyl-Si(O—C₁-C₆-alkyl)₃ saturated or unsaturated, unsubstituted.

In a particularly preferred embodiment of the carboxyterminated polymer according to the invention,
the “polymer” is obtainable by copolymerization of 1,3-butadiene with styrene;
R₁ is —CH₂CH₂—;
R₂ is —CH₃;
R₃ is —CH₃; and
R₄ is —CH₂—CHCₖH₂ₖ₊₁— wherein k is an integer of from 8 to 16; —CH₂CH((CH₂)₁₋₅Si(OC₁-C₄-alkyl)₃); —CH═CC₁-C₄-alkyl-, or —(CH₂)₂₋₄—.

In a particularly preferred embodiment of the carboxyterminated polymer according to the invention,
the “polymer” is obtainable by copolymerization of 1,3-butadiene with styrene;
R₁ is —CH₂CH₂—;
R₂ is —CH₃;
R₃ is —CH₃; and
R₄ is —CH₂—CHC₁₂H₂₃—, —CH₂CH(CH₂CH₂CH₂Si(OCH₃)₃), —CH═CCH₃—, or —CH₂CH₂—CH₂—.

Another aspect of the invention relates to the successive use of first a cyclic urea derivative and then a cyclic carboxylic acid anhydride as functionalizing reagents for the preparation of the invention end group-functionalized diene rubbers with end groups of the formulae (I) or (II) as described herein.

The end group functionalized polymers according to the invention preferably have average molecular weights (number average, Mn) of 10,000 to 2,000,000 g/mol, preferably of 100,000 to 1,000,000 g/mol and glass transition temperatures of −110° C. to +20° C., preferably of −110° C. to 0° C., and Mooney viscosities [ML 1+4 (100° C.)] of 10 to 200, preferably of 30 to 150 Mooney units.

Another aspect of the invention is a process for the preparation of the inventive end group functionalized polymers, according to which one or more compounds of the formula (III), as pure substance, solution or suspension, are first added to polymers with reactive polymer chain ends. Addition preferably takes place after completion of polymerization, but may also take place before complete monomer conversion. The reaction of compounds of formula (III) with polymers having reactive polymer chain ends preferably takes place at the temperatures normally used for polymerization. The reaction times for the reaction of compounds of the formula (III) with the reactive polymer chain ends may range from a few minutes to several hours.

The amount of these compounds can be selected so that all reactive polymer chain ends react with compounds of the formula (III), or an undersupply of these compounds can be used. The amounts of compounds of formula (III) used can cover a wide range. The preferred amounts are in the range from 0.3 to 2 molar equivalents, particularly preferably in the range from 0.6 to 1.5 molar equivalents based on the amount of initiator or catalyst used for polymerization.

In the subsequent step, compounds of the formula (IV) are then added as pure material, solution or suspension to the polymers obtained from the preceding step by adding compounds of the formula (III). The reaction of compounds of formula (IV) preferably takes place at the temperatures normally used for polymerization. The reaction times for the reaction of compounds of formula (IV) may range from a few minutes to several hours.

The quantities of compounds of formula (IV) used can cover a wide range. The preferred amounts are in the range from 0.3 to 2 molar equivalents, particularly preferably in the range from 0.6 to 1.5 molar equivalents based on the amount of compounds of the formula (III) used.

In addition to compounds of the formula (III) and the formula (IV), the coupling reagents typical for anionic diene polymerization can also be used for reaction with the reactive polymer chain ends. Examples of such coupling reagents are silicon tetrachloride, methyl-trichlorosilane, dimethyldichlorosilane, tin tetrachloride, dibutyltin dichloride, tetraalkoxysilanes, ethylene glycol diglycidyl ether, 1,2,4-tris(chloromethyl)benzene. Such coupling reagents may be added before, together with or after the compounds of formula (III).

After addition of compounds of the formula (III) and formula (IV) and optionally of coupling reagents, the usual antioxidants, such as sterically hindered phenols, aromatic amines, phosphites, thioethers, are preferably added before or during the working up of the carboxyl-terminated or carboxyl-terminated polymers according to the invention. Furthermore, the usual extender oils used for diene rubbers such as TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils can be added. It is also possible to add fillers such as carbon black and silica, rubbers and rubber additives.

The solvent can be removed from the polymerization process by the usual methods, such as distillation, stripping with steam or applying a vacuum, if necessary at higher temperatures.

A further aspect of invention is the use of the end group functionalized polymers according to the invention for the production of vulcanizable rubber compositions.

Preferably, these vulcanizable rubber compositions contain other rubbers, fillers, rubber chemicals, processing aids and extender oils.

Additional rubbers are, for example, natural rubber and synthetic rubber. If present, their quantity is usually in the range from 0.5 to 95% by weight, preferably in the range from 10 to 80% by weight, based on the total polymer quantity in the mixture. The amount of additional rubber added again depends on the intended use of the invention. Examples of such synthetic rubbers are BR (polybutadiene), acrylic acid alkyl ester copolymers, IR (polyisoprene), E-SBR (styrene-butadiene copolymers produced by emulsion polymerization), S-SBR (styrene-butadiene copolymers produced by solution polymerization), IIR (isobutylene-isoprene copolymers), NBR (butadiene-acrylonitrile copolymers), HNBR (partially or completely hydrogenated NBR rubber), EPDM (ethylene-propylene-diene terpolymers) and mixtures of these rubbers. Natural rubber, E-SBR and S—SBR with a glass temperature above −60° C., polybutadiene rubber with a high cis content (>90%) produced with catalysts based on Ni, Co, Ti or Nd, polybutadiene rubber with a vinyl content of up to 80% and mixtures thereof are of particular interest for the manufacture of automotive tires.

All known fillers used in the rubber industry can be considered as fillers for the rubber compositions according to the invention. These include both active and inactive fillers.

Examples include but are not limited to:
highly disperse silicas, produced for example by precipitation of solutions of silicates or flame hydrolysis of silicon halides with specific surfaces of 5-1000, preferably 20-400 m²/g (BET surface) and primary particle sizes of 10-400 nm. Silicas may also be present as mixed oxides with other metal oxides such as Al, Mg, Ca, Ba, Zn, Zr, Ti oxides;
synthetic silicates such as aluminum silicate, alkaline earth silicate such as magnesium silicate or calcium silicate, with BET surfaces of 20-400 m²/g and primary particle diameters of 10-400 nm;
natural silicates such as kaolin, montmorillonite and other naturally occurring silicas;
glass fibers and glass fiber products (mats, strands) or microspheres;
metal oxides such as zinc oxide, calcium oxide, magnesium oxide, aluminum oxide;
metal carbonates, such as magnesium carbonate, calcium carbonate, zinc carbonate;
metal hydroxides, such as aluminum hydroxide, magnesium hydroxide;
metal sulfates, such as calcium sulfate, barium sulfate;
carbon black: The carbon blacks to be used are carbon blacks produced by the flame soot, channel, furnace, gas soot, thermal, acetylene soot or arc process and have BET surfaces of 9-200 m2/g, for example SAF-, ISAF-LS-, ISAF-HM-, ISAF-LM-, ISAF-HS-, CF-, SCF-, HAF-LS-, HAF-, HAF-HS-, FF-HS-, SPF-, XCF-, FEF-LS-, FEF-, FEF-HS-, GPF-HS-, GPF-, APF-, SRF-LS-, SRF-LM-, SRF-HS-, SRF-HM- and MT- soot or according to ASTM N110-, N219-, N220-, N231-, N234-, N242-, N294-, N326-, N327-, N330-, N332-, N339-, N347-, N351-, N356, N358, N375, N472, N539, N550, N568, N650, N660, N754, N762, N765, N774, N787 and N990 carbon blacks;
rubber gels, in particular those based on BR, E-SBR and/or polychloroprene with particle sizes from 5 to 1000 nm.

Highly disperse silicas and/or carbon blacks are preferred as fillers.

These fillers can be used alone or in a mixture. In a particularly preferred form, the rubber compositions contain as fillers a mixture of light fillers, such as highly dispersed silicas, and carbon black, the mixing ratio of light fillers to carbon black being from 0.01:1 to 50:1, preferably from 0.05:1 to 20:1 parts by weight.

The fillers are used in quantities ranging from 10 to 500 parts by weight based on 100 parts by weight rubber. Quantities in the range of 20 to 200 parts by weight are preferred.

In a further embodiment of the invention, the rubber compositions also contain rubber auxiliaries which, for example, improve the processing properties of the rubber compositions, serve to crosslink the rubber compositions, improve the physical properties of the vulcanizates produced from the rubber compositions corresponding to the invention for their special purpose, improve the interaction between the rubber and the filler or serve to bond the rubber to the filler.

Rubber auxiliaries include crosslinking agents such as sulfur or sulfur-supplying compounds, as well as reaction accelerators, antioxidants, heat stabilizers, light stabilizers, ozone stabilizers, processing aids, plasticizers, tackifiers, blowing agents, dyes, pigments, waxes, extenders, organic acids, silanes, retarders, metal oxides, extender oils such as DAE (Distillate Aromatic Extract)-, TDAE (Treated Distillate Aromatic Extract)-, MES (Mild Extraction Solvates)-, RAE (Residual Aromatic Extract)-, TRAE (Treated Residual Aromatic Extract)-, naphthenic and heavy naphthenic oils as well as activators.

The total amount of rubber additives ranges from 1 to 300 parts by weight, based on 100 parts by weight of total rubber. Preferably quantities in the range of 5 to 150 parts by weight of rubber auxiliaries are used.

The vulcanizable rubber compositions can be produced in a single-stage or a multi-stage process, with 2 to 3 mixing stages being preferred. For example, sulfur and accelerator can be added in a separate mixing stage on a roller, with temperatures in the range of 30° C. to 90° C. being preferred. Sulfur and accelerator are preferably added in the final mixing stage.

Aggregates suitable for the production of vulcanizable rubber compositions include rollers, kneaders, internal mixers or mixing extruders.

Another aspect of the invention relates to the use of end-group-functionalized polymers having end groups of the formula (I) or (II) as described herein for the preparation of vulcanizable rubber compositions.

Another aspect of the invention relates to vulcanizable rubber compositions containing a) end-group-functionalized polymers having end groups of the formula (I) or (II) as described herein; optionally together with b) stabilizers, extender oils, fillers, rubbers and/or further rubber auxiliaries.

A further aspect of the invention is the use of the vulcanizable rubber compositions according to the invention for the production of rubber vulcanizates, in particular for the production of tires, in particular tire treads, which exhibit particularly low rolling resistance with high wet slip resistance and abrasion resistance.

The vulcanizable rubber compositions in accordance with the invention are also suitable for the manufacture of molded articles, for example for the manufacture of cable sheaths, hoses, drive belts, conveyor belts, roll linings, shoe soles, sealing rings and damping elements.

Another aspect of the invention relates to a molded article, in particular a tire, obtainable by the above use, i.e. prepared from a vulcanizable rubber composition according to the invention involving vulcanization.

The following examples serve to explain the invention without limiting its scope.

### EXAMPLES

The number-average molecular weight Mn, the polydispersity Mw/Mn and the degree of coupling of the styrene-butadiene rubbers were determined using GPC (PS calibration).

The Mooney viscosity ML(1+4)100° C. was measured according to DIN 52523/52524.

The vinyl and styrene content was determined by FTIR spectroscopy on rubber films.

The glass transition temperature Tg was determined using DSC from the 2nd heating curve at a heating rate of 20 K/min.

The loss factors tan δ were measured at 0° C. and tan δ at 60° C. to determine the temperature-dependent dynamic-mechanical properties. An Eplexor device (Eplexor 500 N) from Gabo was used for this purpose. The measurements were carried out in accordance with DIN 53513 at 10 Hz on Ares strips in the temperature range from −100° C. to 100° C. The Eplexor 500 N was used for this purpose. To determine the strain-dependent dynamic-mechanical properties, ΔG′ was determined as the difference between the shear modulus at 0.5% strain and the shear modulus at 15% strain as well as the maximum loss factor tan δmax. These measurements were determined according to DIN53513-1990 on an MTS elastomer test system on cylinder specimens (20×6 mm) with 2 mm compression at a temperature of 60° C. and a measuring frequency of 10 Hz in the strain range from 0.1% to 40%.

The rebound elasticity was determined at 60° C. according to DIN 53512.

Styrene-butadiene copolymers

### Example 1: Synthesis of Styrene-Butadiene Copolymer, Non-Functionalized (Comparative Example

An inert 20 L reactor was filled with 8.5 kg hexane, 6.1 mmol 2,2-bis(2-tetrahydrofuryl)-propane and 11.1 mmol n-butyllithium (as a 23% solution by weight in hexane) and heated to 41° C. The heating circuit was then closed and 1185 g of 1,3-butadiene and 315 g of styrene were added simultaneously.

It was polymerized under stirring for 40 minutes whereas the reactor contents reached a peak temperature of 66° C. Subsequently, 11.1 mmol n-octanol was added to stop the anionic polymer chain ends. The rubber solution was drained, stabilized by adding 3 g Irganox® 1520 (2,4-bis(octylthiomethyl)-6-methylphenol) and the solvent removed by stripping with steam. The rubber crumbs were dried at 65° C. for 16 h in a vacuum drying oven.

The number-average molecular weight Mn, the molecular weight distribution Mw/Mn, the degree of coupling (all from the GPC measurement with PS calibration), the Mooney viscosity ML1+4@100° C., the vinyl and styrene content (from the FTIR measurement, data in % by weight, based on the total polymer), as well as the glass transition temperature Tg (from the DSC measurement) were determined on the dried rubber crumbs. The values are listed in Table 1.

### Example 2: Functionalization of Styrene-Butadiene Copolymer by Reaction with 1,3-Dimethyl-2-Imidazolidinone (Comparative Example)

The procedure was the same as in example 1. Instead of n-octanol, however, the amount of the functionalization reagent 1,3-dimethyl-2-imidazolidinone (1) equimolar to n-butyllithium was added and the reactor content then stirred for a further 5 minutes. The rubber solution was then drained, stabilized by adding 3 g Irganox® 1520 (2,4-bis(octylthiomethyl)-6-methylphenol) and the solvent removed by stripping with steam. The rubber crumbs were dried at 65° C. for 16 h in a vacuum drying oven.

### Example 3: Functionalization of Styrene-Butadiene Copolymer by Reaction with Citraconic Anhydride (Comparative Example)

The procedure was the same as in example 2. As functionalization reagent, the equimolar amount to n-butyl-lithium of citraconic anhydride (26) was added.

### Example 4: Functionalization of Styrene-Butadiene Copolymer by Successive Reaction with 1,3-dimethyl-2-imidazolidinone and Citraconic Anhydride (Example According to Invention)

The procedure was the same as in example 2. For functionalization, the amount of 1,3-dimethyl-2-imidazolidinone (1) equimolar to n-butyl-lithium was added first. It was stirred for 5 minutes, then the equimolar amount to n-butyllithium of citraconic anhydride (26) was added.

### Example 5: Functionalization of Styrene-Butadiene Copolymer by Reaction with Tetrapropenyl Succinic Anhydride (Comparative Example)

The procedure was the same as in example 2. As functionalization reagent, the amount of tetrapropenyl succinic anhydride (20) equimolar to n-butyl lithium was added.

### Example 6: Functionalization of Styrene-Butadiene Copolymer by Successive Reaction with 1,3-dimethyl-2-imidazolidinone and Tetrapropenyl Succinic Anhydride (Example According to Invention)

The procedure was the same as in example 2. For functionalization, the amount of 1,3-dimethyl-2-imidazolidinone (1) equimolar to n-butyl-lithium was added first. It was stirred for 5 minutes, then the equimolar amount to n-butyllithium of tetrapropenyl succinic anhydride (20) was added.

### Example 7: Functionalization of Styrene-Butadiene Copolymer by Reaction with Glutaric Anhydride (Comparative Example)

The procedure was the same as in example 2. The amount of glutaric anhydride (29) equimolar to n-butyl-lithium was added as functionalization reagent.

### Example 8: Functionalization of Styrene-Butadiene Copolymer by Successive Reaction with 1,3-dimethyl-2-imidazolidinone and Glutaric Anhydride (Example According to Invention)

The procedure was the same as in example 2. For functionalization, the amount of 1,3-dimethyl-2-imidazolidinone (1) equimolar to n-butyl-lithium was added first. It was stirred for 5 minutes and then the equimolar amount to n-butyllithium of glutaric anhydride (29) was added.

### Example 9: Functionalization of Styrene-Butadiene Copolymer by Reaction with 3-(trimethoxysilyl)propyl Succinic Anhydride (Comparative Example)

The procedure was the same as in example 2. As functionalization reagent, the amount of 3-(trimethoxysilyl)propyl succinic anhydride (22) equimolar to n-butyl lithium was added.

### Example 10: Functionalization of Styrene-Butadiene Copolymer by Successive Reaction with 1,3-dimethyl-2-imidazolidinone and 3-(trimethoxysilyl)-propyl Succinic Anhydride (Example According to Invention)

The procedure was the same as in example 2. For functionalization, the amount of 1,3-dimethyl-2-imidazolidinone (1) equimolar to n-butyl-lithium was added first. It was stirred for 5 minutes, then the equimolar amount to n-butyllithium of 3-(trimethoxysilyl)propyl succinic anhydride (22) was added.

The polymer properties of the styrene-butadiene copolymers from examples 1-10 are summarized in Table 1. Table 1 shows that the carboxy-terminated polymers of examples 4, 6, 8 and 10, prepared by successive addition of the two functionalization reagents according to formula (III) and (IV), according to the invention, have significantly reduced coupling degrees compared to the polymers of examples 3, 5, 7 and 9, prepared by addition of functionalization reagents according to formula (IV) without prior addition of a functionalization reagent according to formula (III). At similar molecular weight, polydispersity and coupling levels as the polymers of comparison examples 1 and 2, the carboxy terminated polymers of examples 4, 6, 8 and 10 according to invention exhibit significantly higher Mooney viscosities. This can be explained by the association formation of the carboxyterminated polymers via the carboxy or carboxylate end groups in the undiluted state (relevant for Mooney measurement), which is no longer effective in diluted solution (relevant for GPC measurement).

Rubber Compounds

Tire tread rubber compounds containing the styrene-butadiene copolymers of examples 1-10 were produced. The components are listed in Table 2. The components (without sulfur and accelerator) were mixed in a 1.5 L kneader. The components sulfur and accelerator were mixed in on a roller at 40° C. The individual steps in the preparation of the mixture are listed in Table 3.

TABLE 1
Properties of the styrene-butadiene copolymers according to Examples 1-10

| | functionalization | functionalization | | | | | | | |
|---|---|---|---|---|---|---|---|---|---|
| | reagent | reagent | | | Degree of | | vinyl- | styrene- | |
| S-SBR from | according to | according to | Mₙ | | coupling | ML1 + 4 | content | content | Tg |
| Example | formula (III) | formula (IV) | [kg/mol] | M_{w}/Mₙ | [%] | [MU] | [wt.-%] | [wt.-%] | [° C.] |
| 1 | — | — | 275 | 1.15 | 0 | 54 | 49.8 | 21.2 | −24.7 |
| (comparative) | | | | | | | | | |
| 2 | (1) | — | 261 | 1.19 | 1 | 57 | 50.9 | 21.1 | −23.6 |
| (comparative) | | | | | | | | | |
| 3 | — | (26) | 254 | 1.52 | 42 | 81 | 50.5 | 20.9 | −23.5 |
| (comparative) | | | | | | | | | |
| 4 | (1) | (26) | 200 | 1.28 | 1 | 76 | 50.1 | 21.0 | −25.1 |
| (inventive) | | | | | | | | | |
| 5 | — | (20) | 241 | 1.66 | 51 | 75 | 50.0 | 21.0 | −24.3 |
| (comparative) | | | | | | | | | |
| 6 | (1) | (20) | 238 | 1.29 | 4 | 67 | 49.9 | 21.4 | −24.2 |
| (inventive) | | | | | | | | | |
| 7 | — | (29) | 248 | 1.64 | 51 | 72 | 50.5 | 20.3 | −25.2 |
| (comparative) | | | | | | | | | |
| 8 | (1) | (29) | 264 | 1.20 | 3 | 83 | 51.3 | 21.3 | −22.8 |
| (inventive) | | | | | | | | | |
| 9 | — | (22) | 365 | 3.23 | 72 | 80 | 49.6 | 21.0 | −25.4 |
| (comparative) | | | | | | | | | |
| 10 | (1) | (22) | 239 | 1.95 | 17 | 72 | 49.3 | 21.0 | −26.0 |
| (inventive) | | | | | | | | | |

TABLE 2
Components of tire tread rubber compounds (Specifications
in phr: parts by weight per 100 parts by weight rubber)

| | |
|---|---|
| Styrene-butadiene copolymer | 70 |
| High-cis polybutadiene (BUNA CB 24 from Arlanxeo | 30 |
| Deutschland GmbH) | |
| Silica (Ultrasil ® 7000) | 90 |
| Carbon black (Vulcan ® J/N 375) | 7 |
| TDAE oil (Vivatec 500) | 36.3 |
| Processing aid (Aflux 37) | 3 |
| Stearic acid (Edenor C 18 98-100) | 1 |
| Antioxidant (Vulkanox ® 4020/LG der Lanxess | 2 |
| Deutschland GmbH) | |
| Antioxidant (Vulkanox ® HS/LG der Lanxess | 2 |
| Deutschland GmbH) | |
| Zink oxide (Zinkweiβ Rotsiegel) | 3 |
| Light protection wax (Antilux 654) | 2 |
| Silane (Si 69 ® from Evonik) | 7.2 |
| Diphenylguanidine (Rhenogran DPG-80) | 2.75 |
| Sulfenamide (Vulkacit ® NZ/EGC from Lanxess | 1.6 |
| Deutschland GmbH) | |
| Sulphur (Mahlschwefel 90/95 Chancel) | 1.6 |
| Sulfonamide (Vulkalent ® E/C) | 0.2 |

TABLE 3
Preparation

| Step 1: | 0 | seconds | Addition of polymers |
|---|---|---|---|
| Mixing in a | 30 | seconds | Addition of ⅔ silica, ⅔ silane, stearic |
| 1.5 litre | | | acid, wax, antioxidant, carbon black |
| kneader | 90 | seconds | Addition of residual silica and silane |
| | 150 | seconds | Addition of zinc oxide |
| | 240 | seconds | Heat up to 150° C., hold |
| | | | at temperature for 3 min |
| | 420 | seconds | Ejection |
| Step 2: | Cut the sheet three times left and | | |
| Mixing on | right followed by 3 revolutions at | | |
| the roller | 40° C. and a nip of 4 mm | | |
| Step 3: | 24 hours storage at 24° C. | | |
| Step 4: | 0 | seconds | Addition of the compound from step 3 |
| Mixing in a | 30 | seconds | Heat up to 150° C., hold |
| 1.5 litre | | | at temperature for 3 min |
| kneader | 210 | seconds | Ejection |

| | |
|---|---|
| Step 5: | Addition of sulphur and accelerator, |
| Mixing on | cut the sheet three times |
| the roller | left and right followed by 3 rounds |
| | at 40° C. and a nip of 4 mm |

The rubber compounds were vulcanized at 160° C. for 20 minutes. The physical properties of the corresponding vulcanizates 11-20 are listed in Table 4. The vulcanizate properties of the vulcanized rubber compound from comparison example 11 with the non-functionalized styrene-butadiene copolymer as the compound component are given an index of 100. All values greater than 100 in Table 4 indicate a corresponding percentage improvement of the respective test property.

TABLE 4
Properties of vulcanizates

| | contains | | | | | |
|---|---|---|---|---|---|---|
| | S-SBR | Tan | Tan | | | rebound |
| Vulcanizate | from | δ at | δ at | Tan δ | | elasticity |
| Example | Example | 0° C. | 60° C. | Maximum | ΔG′ | at 60° C. |
| 11 | 1 | 100 | 100 | 100 | 100 | 100 |
| (compar- | | | | | | |
| ative) | | | | | | |
| 12 | 2 | 109 | 106 | 107 | 121 | 101 |
| (compar- | | | | | | |
| ative) | | | | | | |
| 13 | 3 | 108 | 105 | 105 | 125 | 102 |
| (compar- | | | | | | |
| ative) | | | | | | |
| 14 | 4 | 106 | 110 | 109 | 129 | 107 |
| (inven- | | | | | | |
| tive) | | | | | | |
| 15 | 5 | 103 | 105 | 107 | 130 | 100 |
| (compar- | | | | | | |
| ative) | | | | | | |
| 16 | 6 | 107 | 126 | 112 | 154 | 105 |
| (inven- | | | | | | |
| tive) | | | | | | |
| 17 | 7 | 105 | 112 | 105 | 129 | 98 |
| (compar- | | | | | | |
| ative) | | | | | | |
| 18 | 8 | 114 | 119 | 111 | 136 | 102 |
| (inven- | | | | | | |
| tive) | | | | | | |
| 19 | 9 | 116 | 108 | 107 | 143 | 108 |
| (compar- | | | | | | |
| ative) | | | | | | |
| 20 | 10 | 115 | 114 | 108 | 159 | 111 |
| (inven- | | | | | | |
| tive) | | | | | | |

The rebound elasticity at 60° C., the loss factor tan δ at 60° C. from the temperature-dependent dynamic-mechanical measurement as well as the tan δ maximum and the modulus difference G′ between low and high strain from the strain-dependent dynamic-mechanical measurement are indicators for the rolling resistance in the tire. The loss factor tan δ at 0° C. is an indicator for the wet slip resistance of the tire.

As can be seen from Table 4, all vulcanizates containing functionalized diene rubbers are characterized by improved values for the wet grip indicator and the rolling resistance indicators. The vulcanizates from the inventive examples 14, 16, 18 and 20 have better properties than the vulcanizates from the corresponding examples 13, 15, 17 and 19, in which styrene-butadiene rubbers were used which were only reacted with cyclic anhydrides.

1. A carboxyterminated polymer according to general formula (I), 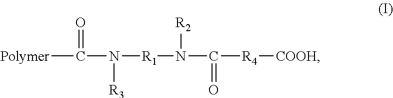
wherein
the polymer contains at least one carbon-carbon double bond;
R₂, R₃ are identical or different and represent saturated or unsaturated organic radicals which, in addition to C and H, may contain one or more heteroatoms independently selected from the group consisting of O, N, S, and Si; and
R₁, R₄ are identical or different and represent saturated or unsaturated divalent organic radicals which, in addition to C and H, may contain one or more heteroatoms independently selected from the group consisting of O, N, S, and Si.

2. The carboxyterminated polymer according to claim 1, which is obtained by a polymerization reaction comprising polymerizing one or more dienes selected from the group consisting of 1,3-butadiene, isoprene, 1,3-pentadiene, 2,3-dimethylbutadiene, 1-phenyl-1,3-butadiene and 1,3-hexadiene.

3. The carboxyterminated polymer according to claim 2, wherein the polymer is obtainable by
homo- or copolymerization of 1,3-butadiene, isoprene, 1,3-pentadiene, 2,3-dimethylbutadiene, 1-phenyl-1,3-butadiene or 1,3-hexadiene; or
copolymerization of
(i) 1,3-butadiene, isoprene, 1,3-pentadiene, 2,3-dimethylbutadiene, 1-phenyl-1,3-butadiene, 1,3-hexadiene, and combinations thereof with
(ii) a vinyl aromatic monomer selected from the group consisting of styrene, o-, m- and/or p-methylstyrene, p-tert-butylstyrene, methylstyrene, vinylnaphthalene, divinylbenzene, trivinylbenzene, divinylnaphthalene, and combinations thereof.

4. The carboxyterminated polymer according to claim 3, which is obtained by copolymerization of 1,3-butadiene with styrene; or isoprene with styrene.

5. (canceled)

6. The carboxyterminated polymer according to claim 1, wherein
R₁ is selected from the group consisting of
(i) —C₁-C₆-alkylene-, saturated or unsaturated, unsubstituted, mono- or polysubstituted;
(ii) —C₁-C₆-heteroalkylene-, saturated or unsaturated, unsubstituted, mono- or polysubstituted; and
(iii) 6-14-membered arylene, unsubstituted, mono- or polysubstituted;
R₂ is selected from the group consisting of
(i) —C₁-C₂₄-alkyl, saturated or unsaturated, unsubstituted, mono- or polysubstituted; or
(ii) —C₁-C₂₄-heteroalkyl, saturated or unsaturated, unsubstituted, mono- or polysubstituted;
(iii) 6-24-membered aryl, unsubstituted, mono- or polysubstituted, wherein said 6-24-membered aryl is optionally connected through —C₁-C₆-alkylene- or —C₁-C₆-heteroalkylene-, in each case saturated or unsaturated, unsubstituted, mono- or polysubstituted;
(iv) 5-24-membered heteroaryl, unsubstituted, mono- or polysubstituted; wherein said 5-24-membered heteroaryl is optionally connected through —C₁-C₆-alkylene- or —C₁-C₆-heteroalkylene-, in each case saturated or unsaturated, unsubstituted, mono- or polysubstituted;
(v) 3-24-membered cycloalkyl, saturated or unsaturated, unsubstituted, mono- or polysubstituted; wherein said 3-24-membered cycloalkyl is optionally connected through —C₁-C₆-alkylene- or —C₁-C₆-heteroalkylene-, in each case saturated or unsaturated, unsubstituted, mono- or polysubstituted; and
(vi) 3-24-membered heterocycloalkyl, saturated or unsaturated, unsubstituted, mono- or polysubstituted; wherein said 3-24-membered heterocycloalkyl is optionally connected through —C₁-C₆-alkylene- or —C₁-C₆-heteroalkylene-, in each case saturated or unsaturated, unsubstituted, mono- or polysubstituted;
R₃ is selected from the group consisting of
(i) —C₁-C₂₄-alkyl, saturated or unsaturated, unsubstituted, mono- or polysubstituted;
(ii) —C₁-C₂₄-heteroalkyl, saturated or unsaturated, unsubstituted, mono- or polysubstituted;
(iii) 6-24-membered aryl, unsubstituted, mono- or polysubstituted, wherein said 6-24-membered aryl is optionally connected through —C₁-C₆-alkylene- or —C₁-C₆-heteroalkylene-, in each case saturated or unsaturated, unsubstituted, mono- or polysubstituted;
(iv) 5-24-membered heteroaryl, unsubstituted, mono- or polysubstituted; wherein said 5-24-membered heteroaryl is optionally connected through —C₁-C₆-alkylene- or —C₁-C₆-heteroalkylene-, in each case saturated or unsaturated, unsubstituted, mono- or polysubstituted;
(v) 3-24-membered cycloalkyl, saturated or unsaturated, unsubstituted, mono- or polysubstituted; wherein said 3-24-membered cycloalkyl is optionally connected through —C₁-C₆-alkylene- or —C₁-C₆-heteroalkylene-, in each case saturated or unsaturated, unsubstituted, mono- or polysubstituted; and
(vi) 3-24-membered heterocycloalkyl, saturated or unsaturated, unsubstituted, mono- or polysubstituted; wherein said 3-24-membered heterocycloalkyl is optionally connected through —C₁-C₆-alkylene- or —C₁-C₆-heteroalkylene-, in each case saturated or unsaturated, unsubstituted, mono- or polysubstituted;
R₄ is selected from the group consisting of
(i) —C₁-C₆-alkylene-, saturated or unsaturated, unsubstituted, mono- or polysubstituted;
(ii) —C₁-C₆-heteroalkylene-, saturated or unsaturated, unsubstituted, mono- or polysubstituted; and
(iii) 6-14-membered arylene, unsubstituted, mono- or polysubstituted;
wherein “mono- or polysubstituted” means substituted with one substituent in the case of “monosubstituted” or with more than one substituents in the case of “polysubstituted”, wherein the substituents independently of one another are selected from the group consisting of —F, —Cl, —Br, —I, —CN, ═O, —CF₃, —CF₂H, —CFH₂, —CF₂C₁, —CFCl₂, —C₁-C₁₈-alkyl, which is saturated or unsaturated, unsubstituted, and —C₁-C₁₈-heteroalkyl, which is saturated or unsaturated, unsubstituted.

7. The carboxyterminated polymer according to claim 6, wherein
R₁ is (i) —C₁-C₆-alkylene-, saturated or unsaturated, unsubstituted;
R₂ is (i) —C₁-C₆-alkyl, saturated or unsaturated, unsubstituted;
R₃ is (i) —C₁-C₆-alkyl, saturated or unsaturated, unsubstituted;
R₄ is (i) —C₁-C₆-alkylene-, saturated or unsaturated, unsubstituted, mono- or polysubstituted;
wherein substituents for “mono- or polysubstituted” are independently of one another selected from
—F, —Cl, —Br, —I, —CN, —CF₃, —CF₂H, —CFH₂, —CF₂C₁, —CFCl₂,
—C₁-C₈-alkyl, which is saturated or unsaturated, unsubstituted, and
—C₁-C₈-heteroalkyl, which is saturated or unsaturated, unsubstituted.

8. The carboxyterminated polymer according to claim 1, wherein
the polymer is obtained by copolymerization of 1,3-butadiene with styrene;
R₁ is —C₁-C₃-alkylene-, saturated or unsaturated, unsubstituted;
R₂ is —C₁-C₂-alkyl, saturated or unsaturated, unsubstituted;
R₃ is —C₁-C₂-alkyl, saturated or unsaturated, unsubstituted; and
R₄ is selected from —CH₂—CHCₖH₂ₖ₊₁—, wherein k is an integer of from 8 to 16; —CH₂CH((CH₂)₁₋₅Si(OC₁-C₄-alkyl)₃); —CH═CC₁-C₄-alkyl-, and —(CH₂)₂₋₄—.

9. The carboxyterminated polymer according to claim 1, which is present as a carboxylate according to general formula (II), 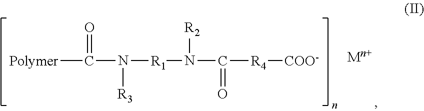
wherein
polymer, R₁, R₂, R₃ and R₄ are as defined in claim 1;
n is an integer from 1 to 4; and
M is a metal or semi-metal of valency 1 to 4.

10. A method for the preparation of a carboxyterminated polymer according to general formula (I), 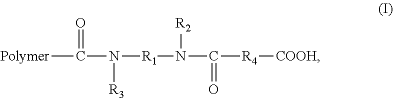
or general formula (II), 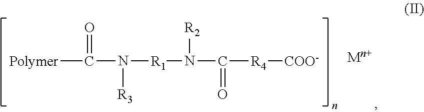
the method comprising:
(a) providing a polymer containing at least one carbon-carbon double bond;
(b) providing a cyclic urea derivative of the general formula (III) 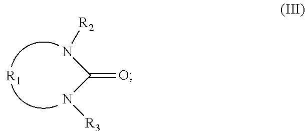
(c) providing a cyclic carboxylic anhydride of the general formula (IV) 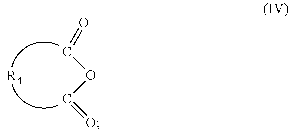
(d) adding the cyclic urea derivative of general formula (III) to the polymer as a first functionalization reagent to form a functionalized polymer intermediate; and
(e) subsequently adding the cyclic carboxylic anhydride of the general formula (IV) to the functionalized polymer intermediate as a second functionalization reagent to form the carboxyterminated polymer according to general formula (I) or the carboxylate according to general formula (II);
wherein
R₂, R₃ are identical or different and represent saturated or unsaturated organic radicals which, in addition to C and H, may contain one or more heteroatoms independently selected from the group consisting of O, N, S and Si; and
R₁, R₄ are identical or different and represent saturated or unsaturated divalent organic radicals which, in addition to C and H, may contain one or more heteroatoms independently selected from the group consisting of O, N, S and Si.

11. The method according to claim 10, wherein step (a) is performed by
an anionic solution polymerization, or
a polymerization using a coordination catalyst.

12. The method according to claim 10, wherein step (a) is performed in the presence of
a solvent selected from the group consisting of cyclohexane, methylcyclopentane, n-hexane, and mixtures thereof; and
an initiator.

13. The method according to claim 10, wherein step (a) is performed within a period of 10 minutes to 8 hours.

14. The method according to claim 10, which further comprises adding
(f) a coupling reagent before, together with or after addition of the cyclic urea derivative of general formula (III); and/or
(g) an antioxidant after the cyclic urea derivative of the general formula (III) and the cyclic carboxylic anhydride of general formula (IV) have been added; and/or
(h) an extender oil; and/or
(i) a filler; and/or
(j) rubbers and/or rubber additives.

15. (canceled)

16. The method according to claim 10, wherein the polymer is obtainable by a polymerization reaction comprising the polymerization of one or more dienes wherein the one or more dienes are selected from the group consisting of 1,3-butadiene, isoprene, 1,3-pentadiene, 2,3-dimethylbutadiene, 1-phenyl-1,3-butadiene or 1,3-hexadiene.

17. The method according to claim 10, wherein the polymer is obtainable by a copolymerization of (i) 1,3-butadiene, isoprene, 1,3-pentadiene, 2,3-dimethylbutadiene, 1-phenyl-1,3-butadiene, 1,3-hexadiene or a combination thereof with (ii) a vinylaromatic monomer selected from the group consisting of styrene, o-, m- and/or p-methylstyrene, p-tert-butylstyrene, methylstyrene, vinylnaphthalene, divinylbenzene, trivinylbenzene, divinylnaphthalene or a combination thereof.

18. The method according to claim 10, wherein the polymer is obtainable by a copolymerization of 1,3-butadiene with styrene or by a copolymerization of isoprene with styrene.

19. The method according to claim 10, wherein
R₁ is selected from the group consisting of
(i) a —C₁-C₆-alkylene- that is saturated or unsaturated and that is unsubstituted, mono- or polysubstituted;
(ii) a —C₁-C₆-heteroalkylene- that is saturated or unsaturated and that is unsubstituted, mono- or polysubstituted; and
(iii) a 6 to 14-membered arylene that is unsubstituted, mono- or polysubstituted;
R₂ is selected from the group consisting of
(i) a —C₁-C₂₄-alkyl that is saturated or unsaturated and that is unsubstituted, mono- or polysubstituted; or
(ii) a —C₁-C₂₄-heteroalkyl that is saturated or unsaturated and that is unsubstituted, mono- or polysubstituted;
(iii) a 6 to 24-membered aryl that is unsubstituted, mono- or polysubstituted, wherein said 6 to 24-membered aryl is optionally connected through —C₁-C₆-alkylene- or —C₁-C₆-heteroalkylene-, which in each case is saturated or unsaturated and which is unsubstituted, mono- or polysubstituted;
(iv) a 5 to 24-membered heteroaryl that is unsubstituted, mono- or polysubstituted, wherein said 5 to 24-membered heteroaryl is optionally connected through a —C₁-C₆-alkylene- or a —C₁-C₆-heteroalkylene-, which in each case is saturated or unsaturated and which is unsubstituted, mono- or polysubstituted;
(v) a 3 to 24-membered cycloalkyl that is saturated or unsaturated and unsubstituted, mono- or polysubstituted wherein said 3 to 24-membered cycloalkyl is optionally connected through a —C₁-C₆-alkylene- or a —C₁-C₆-heteroalkylene-, which in each case is saturated or unsaturated and which is unsubstituted, mono- or polysubstituted; and
(vi) a 3 to 24-membered heterocycloalkyl that is saturated or unsaturated and that is unsubstituted, mono- or polysubstituted, wherein said 3 to 24-membered heterocycloalkyl is optionally connected through a —C₁-C₆-alkylene- or a —C₁-C₆-heteroalkylene-, which in each case is saturated or unsaturated and which is unsubstituted, mono- or polysubstituted;
R₃ is selected from the group consisting of
(i) a —C₁-C₂₄-alkyl that is saturated or unsaturated and that is unsubstituted, mono- or polysubstituted;
(ii) a —C₁-C₂₄-heteroalkyl that is saturated or unsaturated and that is unsubstituted, mono- or polysubstituted;
(iii) a 6 to 24-membered aryl that is unsubstituted, mono- or polysubstituted, wherein said 6 to 24-membered aryl is optionally connected through a —C₁-C₆-alkylene- or a —C₁-C₆-heteroalkylene-, which in each case is saturated or unsaturated, and which is unsubstituted, mono- or polysubstituted;
(iv) a 5 to 24-membered heteroaryl that is unsubstituted, mono- or polysubstituted, wherein said 5 to 24-membered heteroaryl is optionally connected through a —C₁-C₆-alkylene- or a —C₁-C₆-heteroalkylene-, which in each case is saturated or unsaturated and which is unsubstituted, mono- or polysubstituted;
(v) a 3 to 24-membered cycloalkyl that is saturated or unsaturated and that is unsubstituted, mono- or polysubstituted; wherein said 3 to 24-membered cycloalkyl is optionally connected through a —C₁-C₆-alkylene- or a —C₁-C₆-heteroalkylene-, which in each case is saturated or unsaturated and which is unsubstituted, mono- or polysubstituted; and
(vi) a 3 to 24-membered heterocycloalkyl, that is saturated or unsaturated and that is unsubstituted, mono- or polysubstituted, wherein said 3 to 24-membered heterocycloalkyl is optionally connected through a —C₁-C₆-alkylene- or a —C₁-C₆-heteroalkylene-, which in each case is saturated or unsaturated and which is unsubstituted, mono- or polysubstituted;
R₄ is selected from the group consisting of
(i) a —C₁-C₆-alkylene-, that is saturated or unsaturated and that is unsubstituted, mono- or polysubstituted;
(ii) a —C₁-C₆-heteroalkylene-, that is saturated or unsaturated and that is unsubstituted, mono- or polysubstituted; and
(iii) a 6 to 14-membered arylene, that is unsubstituted, mono- or polysubstituted;
wherein “mono- or polysubstituted” means substituted with one substitutent in case of “monosubstituted” and with one or more substituents in case of “polysubstituted” and wherein the substituents are selected independently from the group consisting of —F, —Cl, —Br, —I, —CN, ═O, —CF₃, —CF₂H, —CFH₂, —CF₂C₁, —CFCl₂, a —C₁-C₁₈-alkyl that is saturated or unsaturated and that is unsubstituted, and a —C₁-C₈-heteroalkyl that is saturated or unsaturated and that is unsubstituted.

20. The method according to claim 10, wherein
R₁ is (i) a —C₁-C₆-alkylene- that is saturated or unsaturated, and that is unsubstituted;
R₂ is (i) a —C₁-C₆-alkyl that is saturated or unsaturated and that is unsubstituted;
R₃ is (i) a —C₁-C₆-alkyl that is saturated or unsaturated and that is unsubstituted;
R₄ is (i) a —C₁-C₆-alkylene- that is saturated or unsaturated and that is unsubstituted, mono- or polysubstituted;
wherein “mono- or polysubstituted” means substituted with one substitutent in case of “monosubstituted” or with more than one substituents in case of “polysubstituted” and where the substituents are selected independently from the group consisting of
—F, —Cl, —Br, —I, —CN, —CF₃, —CF₂H, —CFH₂, —CF₂C₁, —CFCl₂,
a —C₁-C₈-alkyl that is saturated or unsaturated and that is unsubstituted, and
a —C₁-C₈-heteroalkyl that is saturated or unsaturated and that is unsubstituted.

21. The method according to claim 10, wherein
the polymer is obtainable by a copolymerization of 1,3-butadiene with styrene;
R₁ is a —C₁-C₃-alkylene- that is saturated or unsaturated and that is unsubstituted;
R₂ is a —C₁-C₂-alkyl that is saturated or unsaturated and that is unsubstituted;
R₃ is a —C₁-C₂-alkyl that is saturated or unsaturated and that is unsubstituted; and
R₄ is selected from —CH₂—CHCₖH₂ₖ₊₁—, —CH₂CH((CH₂)₁₋₅Si(OC₁-C₄-alkyl)₃)-, —CH═C—(C₁-C₄-alkyl)-, and —(CH₂)₂₋₄—, wherein k is an integer of from 8 to 16.

22. A molded article prepared by vulcanizing a vulcanizable composition comprising the carboxy-terminated polymer of claim 1.

23. A tire prepared by vulcanizing a vulcanizable composition comprising the carboxy-terminated polymer of claim 1.
